(19) United States
(12) Patent Application Publication
(10) Pub. No.: US 2003/0070120 A1
(43) Pub. Date: Apr. 10, 2003

(54) Method and system for managing software testing

(75) Inventors: Gartner Jason Michael, Richmond Hill (CA); Luiz Marcelo Aucelio Paternostro, Markham (CA); Harm Sluiman, Scarborough (CA)

Correspondence Address: John L. Rogitz, Rogitz & Associates, 750 B Street, Suite 3120, San Diego, CA, 92101, US

(73) Assignee: International Business Machines Corporation, Armonk, NY

(21) Appl. No.: 10/136,073

(22) Filed: Apr. 30, 2002

(30) Foreign Application Priority Data
Oct. 5, 2001 (CA) 2,358,563

(51) Int. Cl. G06F 11/36

(52) U.S. Cl. 714/38

(57) ABSTRACT

The present invention provides a method and a system for managing a computer software testing process and permitting interactive involvement with test case data. The system manages interactions with manual test cases, presenting the test cases for display and providing a means for collecting execution results data for the entire test case or for selections of the test case. The system of the present invention provides mechanism for interacting with individual steps of a test case.

### I. FIELD OF THE INVENTION

The present invention relates to methods and systems for managing a computer software testing process and more particularly to a method and system for managing test cases for manual testing of software.

### II. BACKGROUND OF THE INVENTION

Software is typically tested using both automated test cases and manual tests in which a person follows a series of steps designed to verify proper operation of the software under a variety of operating conditions. Automatic testing often involves a program that drives an interface or some other aspect of the software being tested and checks results against a set of ideal responses, logging all responses that do not correspond with the set of ideal values. Manual testing may involve the running of verification testing tools or execution of a series of standard user operations.

Multiple test cases, for both automatic and manual testing, may be used to test the software under different conditions. These test cases, and corresponding expected and/or achieved results, with their multiple versions need to be organized and managed. Whether the versions apply to individual test cases or to individual elements of the test cases, the need to manage versions of test data further compounds the complexity of the testing process. When these test cases and data are accessed by multiple people during the test process, the complexity in the management of these random accesses to a set of test data is amplified.

Tools for the execution and management of test results are widely available for automatic software testing. However, these tools have difficulty monitoring test case execution on a computer system remote from that of the management tool, thus necessitating a degree of manual consolidation of the results. Further, such tools do not include functionality for tracking manual test cases.

General workflow tools may be reconfigured to perform basic manual test case management, but this is manually intensive and highly error prone. As most of the results reporting for manual testing is incremental, the inconvenience often results in batch reporting of results to the system. During the execution of a test case, notes about the execution are typically compiled then reported only after test case execution has been completed. This process is error prone and introduces what can sometimes be a significant time delay in making the results of the execution of a test case available.

When analyzing progress and product stability during the testing process, results must be compared to previous results to achieve a true view of the progress of the product. That is, the results of testing for the current release must be compared with the results of previous releases to gain an accurate account of the position of the software in a release cycle.

There is a need for a centralized test management system that can be used for manual test cases and allows for the analysis of past and present releases.

### SUMMARY OF THE INVENTION

It is an object of the present invention to provide a method and system for management of manual test case information.

In an exemplary embodiment the present invention provides a system for managing a computer software testing process and permitting interactive involvement with test case data. The system manages interactions with manual test cases, presenting the test cases for display and providing a mechanism for collecting execution results data for the entire test case or for selections of the test case.

In accordance with one aspect of the present invention there is provided a system for managing interaction with test cases for manual testing of software by a test client, the test client displaying the test cases for interaction by a tester, said system comprising: a client interface for communicating with a plurality of clients, the test client being one of said plurality of clients; a data storage containing a test case definition representing a test instruction set of a test case, said test case definition having step definition information with an instruction step to be executed manually and execution status information for said instruction step; interaction means for governing interactions with said test case definition in said data storage, said interaction means providing said test case definition to said client interface for display on the test client; and step manipulation means for handling manipulation of said instruction step of said test case definition in said data storage; wherein the test client provides said client interface with a manipulation command for said test case definition and said interaction means governs said manipulation command for said test case definition in said data storage.

In accordance with another aspect of the present invention there is provided a system for managing interaction with test cases for manual testing of software by a test client in communication with a data storage containing a test case definition representing a test instruction set of a test case, said test case definition having step definition information including an instruction step to be executed manually and execution status information for said instruction step, the test client displaying the test cases for interaction by a tester, said system comprising: a client interface for communicating with a plurality of clients, the test client being one of said plurality of clients; interaction means in communication with the data storage for governing interactions with said test case definition in said data storage, said interaction means providing said test case definition to said client interface for display on the test client; and step manipulation means in communication with the data storage for handling manipulation of said instruction step of said test case definition in said data storage; wherein the test client provides said client interface with a manipulation command for said test case definition and said interaction means governs said manipulation command for said test case definition in said data storage.

In accordance with a further aspect of the present invention there is provided a method of managing test cases for manual testing of software from a test client, information representing the test cases being stored in a data storage, said method comprising: (a) receiving test case definition information from the test client representing a test case; (b) creating a data structure in the data storage representing said test case definition information, said data structure including test case identification, a test instruction set having step definition information including an instruction step to be executed manually and execution status information for said instruction step, and test case execution information; (c) receiving a manipulation command for said data structure from the test client, said manipulation command having step definition information; (d) updating said step definition information in said data structure based on said step definition information in said manipulation command.

In accordance with yet another aspect of the present invention there is provided a computer readable medium having stored thereon computer-executable instructions for managing test cases being stored in a data storage, comprising: (a) receiving test case definition information from the test client representing a test case; (b) creating a data structure in the data storage representing said test case definition information, said data structure including test case identification, a test instruction set having step definition information including an instruction step to be executed manually and execution status information for said instruction step, and test case execution information; (c) receiving a manipulation command for said data structure from the test client, said manipulation command having step definition information; (d) updating said step definition information in said data structure based on said step definition information in said manipulation command.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

The present invention will be described in conjunction with the drawings in which:

FIG. 1 is schematic diagram depicting a computing environment according to embodiments of the present invention;

FIG. 2 is an architecture diagram depicting a system for managing manual software testing according to an embodiment of the present invention; and

FIG. 3 is a diagram depicting a client of the system 100 for managing manual software testing of FIG. 2.

### DETAILED DESCRIPTION OF EMBODIMENTS OF THE PRESENT INVENTION

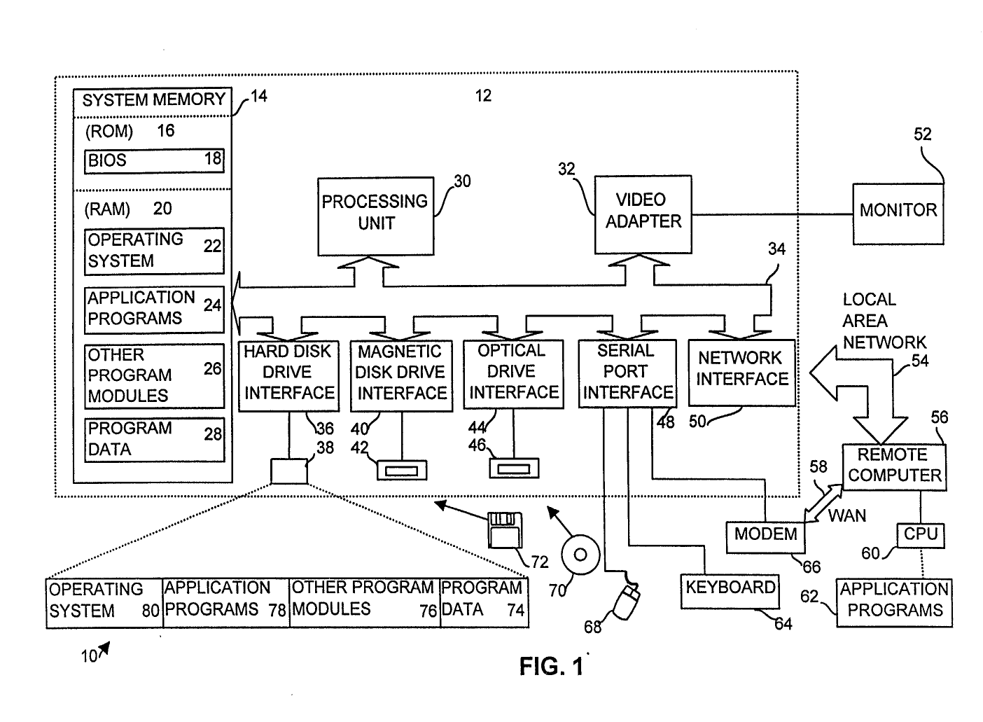

FIG. 1 and the associated description represent an example of a suitable computing environment in which the present invention may be implemented. While the invention will be described in the general context of computer-executable instruction of a computer program that runs on a personal computer, the present invention can also be implemented in combination with other program modules.

Generally, program modules include routines, programs, components, data structures and the like that perform particular tasks or implement particular abstract data types. Further, the present invention can also be implemented using other computer system configurations, including hand-held devices, multiprocessor systems, microprocessor-based or programmable consumer electronics, minicomputers, mainframe computers, and distributed computing environments where program modules may be located in both local and remote memory storage devices.

With reference to FIG. 1, the present invention may be implemented within a general purpose computing device in the form of a conventional personal computer 12, including a processing unit 30, a system memory 14, and a system bus 34 that couples various system components including the system memory 14 to the processing unit 30. The system memory 14 includes read only memory (ROM) 16 and random access memory (RAM) 20.

A basic input/output system 18 (BIOS), containing the basic routines that help to transfer information between elements within the personal computer 12 (e.g., during startup) is stored in ROM 16. The personal computer 12 further includes a hard disk drive 38 for reading from and writing to a hard disk (not shown), a magnetic disk drive 42 for reading from or writing to a removable magnetic disk 72, and an optical disk drive 46 for reading from or writing to a removable optical disk 70 such as a CD ROM or other optical media, all of which are connected to the system bus 34 by respective interfaces 36, 40, 44.

The drives and their associated computer-readable media provide nonvolatile storage of computer readable instructions, data structures, program modules and other data for the personal computer 12. Although the exemplary environment described herein employs certain disks, it should be appreciated by those skilled in the art that other types of computer readable media for storing data may also be employed.

A number of program modules may be stored on the disks 72, 70, ROM 16 or RAM 20, including an operating system 22, one or more application programs 24, other program modules 76, and program data 74. Commands and information may be entered into the personal computer 12 through input devices (e.g., a keyboard 64, pointing device 68, a microphone, joystick, etc.). These input devices may be connected to the processing unit 30 through a serial port interface 48, a parallel port, game port or a universal serial bus (USB). A monitor 52 or other type of display device is also connected to the system bus 34 via an interface, such as a video adapter 32.

The personal computer 12 may operate in a networked environment using logical connections to one or more remote computers 56, such as another personal computer, a server, a router, a network PC, a peer device or other common network node. The logical connections depicted in FIG. 1 include a local area network (LAN) 54 and a wide area network (WAN) 58. Such networking environments are commonplace in offices, enterprise-wide computer networks, intranets and the Internet.

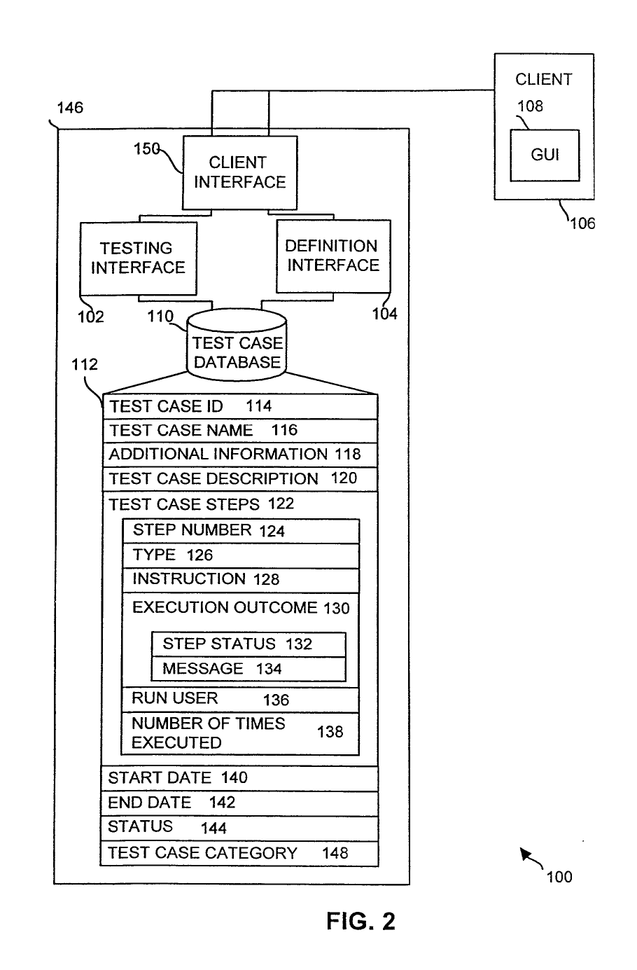

When used in a LAN networking environment, the personal computer 12 is connected to the local network 54 through a network interface or adapter 50. When used in a WAN networking environment, the personal computer 12 typically includes a modem 66 connected to the system bus 34 via the serial port interface 48 or other means for establishing a communications over the wide area network 58, such as the Internet. The operations of the present invention may be distributed between the two computers 12, 56, such that one acts as a server and the other as a client (see FIG. 2). Operations of the present invention for each computer 12, 56 (client and server) may be stored in RAM 20 of each computer 12, 56 as application programs 24, other program modules 26, or on one of the disks 38, 42, 46. It will be appreciated that the network connections shown are exemplary and other means of establishing a communications link between the computers may be used.

Testing Background

Four major components are involved in the process of testing software: reliability testing, functionality testing, application performance testing and system performance testing.

Reliability testing involves detecting run-time errors and memory leaks before they occur and precisely identifying their origin. Error detection is not limited only to applications for which source code is available. For example, application can often include third-party components that require testing. Reliability tools should work within an integrated development environment (IDE) to facilitate their use by developers as well as testing professionals. A reliability testing process should also be repeatable such that once a problem has been discovered there is a method of repeating the steps to reproduce the error. This assists in accelerating the implementation of the fix and is indispensable for follow-up tests after the repair has been made.

The purpose of functional testing is to ensure that the application meets the requirements established for it. For example, testing the functionality of an order entry system would include verifying that the right products were shipped, that the right account was billed, and that credit limits were checked appropriately. Typically, a testing professional builds regression tests by exercising the application as a tool records keyboard and mouse events. The testing professional inserts validation points during the recording stage to ensure that the application is generating the required results. The product of the recording session is generally a reusable script that can then be played back many times to test the application as it progresses through the development to release. Typically such tools support major Enterprise Resource Planning (ERP) environments.

Application performance testing (APT) occurs after a particular feature is operating reliably and correctly. For example, an online order entry system that requires several minutes to check credit limits is clearly unacceptable. Application performance testing should determine exactly why a particular software component is slow by pinpointing the performance bottlenecks. The APT needs to identify where the software is spending its time, and why any specific function is particularly slow. Further, APT should expose purchased components that are not meeting performance specifications and ascertain which system calls, if any, are causing performance problems.

System performance testing is the process of exercising a multi-user distributed system, such as e-commerce, ERP or client-server, by emulating actual users in order to assess the quality, scalability, and performance of the system in a production environment. Typically, an important attribute exposed by system performance testing is the breaking point of the system. This is the point at which the system performance has become unacceptably slow, when the system begins to produce incorrect results, or when the system crashes altogether. System performance testing is a predictive activity. For the results to be meaningful, it is important that the prediction be an accurate reflection of system behavior under production load. To achieve a realistic workload the following considerations must be made: (a) realistic mix of test data for each transaction type; (b) realistic mix of transaction types and user activities; (c) pacing of the test execution must reflect the packing of real user activity; and (d) server responses must be validated as well as timed.

All of the above testing categories are typically accomplished in two ways:

(1) a programmatic test case that drives a user interface or another programmable interface and checks results; and

(2) a manual (or semi-manual) process a tester follows, which typically involves running certain tools that test or verify a result or simply executing a series of steps and verifications.

Manual Software Test Tracking

The present invention is primarily directed to managing interactions with test cases for manual testing of software. That is, the present invention provides a tool for tracking manual testing, especially one that allows for the collection of test data regardless of location.

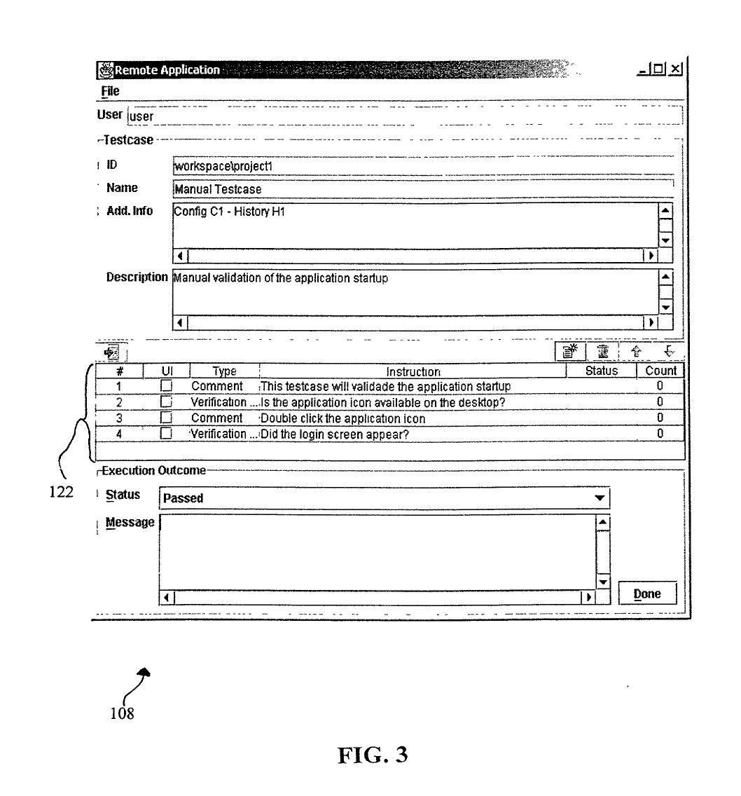

FIG. 2 is an architecture diagram depicting a system 100 for managing manual software testing. The system 100 according to an embodiment of the present invention has a server 146 (residing within a LAN 54 or WAN 58 of FIG. 1 for example) for collecting, storing, and distributing information related to the testing process and a client 106 (such as the computer 12 or the remote computer 56 of FIG. 1) through which test information data may be added, edited and viewed. The client 106 has a graphical user interface (GUI) 108, shown in FIG. 3, through which a user can interact with testing data on the server 146.

The server 146 has a client interface 150 in communication with the client 106 for receiving information from and sending information to the client 106. The client interface 150 is in communication with two interfaces 102, 104 (also termed interface means, interaction means or step interaction means depending on precise functions performed as discussed below) that interface with a test case database 110. The client interface 150 provides the appropriate interface 102, 104 with information form the client 106. The interfaces 102, 104 communicate the client interface 150 to forward information to the client 106. The client interface 150 detects a request to create an entry in the database 110 representing a test case and invokes a definition interface 104. During creation of an entry in the database 110 all information received by the client interface 150 is forwarded to the definition interface 104. When sufficient information to create an entry in the database 110 has been received, the definition interface 104 informs the client interface 150 that creation is complete. Any subsequent information received by the client interface 150 that is not tagged as definition information is forwarded to a testing interface 102. The definition interface 104 and the client interface 102 service client 106 requests to view and manipulate the testing information in the test case database 110.

The definition interface 104 is the interface through which test cases are created. The definition interface 104 provides the GUI 108 with an indication of the information needed to create an entry in the database 110 representing a test case in response to a request from the client 106. The definition interface 104 accepts this information from the client 106 and confirms that it is sufficient to create an entry in the database 110.

The database 110 contains test case definition 112 entries that define a test case designed to verify an aspect of a system. The test cases are steps that are performed in a specified manner to test the system. These steps form a test instruction set 122 in the test case definition 112 in the database 110. The individual elements in the test instruction set 122 are instruction steps. Each instruction step has execution status information 130 representing the status of each step after execution.

Creating a test case definition 112 involves setting a test category 148 (e.g., automatic or manual test), a name 116, a description of the test case 120 and defining the steps of the test case 122. For each instruction step in a test case definition 112 there is a step number 124 for ordering steps according to relative execution times, a step type 126 and the instructions to be executed for the step 128. The step type 126 indicates the purpose of each step. The definition interface 104 accepts information that defines a new test case and creates the test case definition 112 in the test case database 110 using the information provided by the client 106.

The testing interface 102 accesses a test case definition 112 from the database 110 in response to a request from the client 106 to view the test case definition 112. In response to the request from the client 106 to view or edit a test case, the testing interface 102 retrieves the stored information from the database 110 and formats it for display on the client 106. The testing interface 102 will accept changes in status, number of times each step was executed 138 and user that executed the step 136 as well as messages that may be associated with each instruction step. Editorial changes may also be made to the instruction 128 of each instruction step in the database 110 through the testing interface 102 These editorial changes may include changing a step or adding a new step.

An exemplary screen shot of the client 106 GUI 108 is shown in FIG. 3 that allows the steps of a test case to be added or edited. The client 106 also allows the status (including status, number of times executed and run user) to be changed and updated. The GUI 108 displays test case definitions 112 from the test case database 110. The test instruction set 122 displayed on the GUI 108 may be viewed and interacted with to change the status 132 and the execution count 138 for each step as well as add new steps to the test instruction set 122 in the database 110. Additional information regarding the test instruction set 134 and the test case definition 118 may also be added to the database 110 via the GUI 108. A user may viewed the test instruction set 122 via the GUI 108 to perform the test steps. Status 132 for each of these steps may then be added to the test case definition 112 in the database 110 while each step is being performed.

The test case database 110 contains information on a plurality of test cases 112 stored as data structures. Each test case definition 112 has similar descriptive information. Each data structure containing a test case definition 112 is identified by the test case ID 114 identifying what is being tested and the test case name 116. Additional information 118 and the test case description 120 provide a description of the test as well as outline any interfaces that are tested, etc. The test instruction set 122 field of the test case definition 112 contains all steps that define the actions of the test case. Each instruction step has the step number 124 by which it can be defined, the type of step 126 and the instruction action 128 for each step. Each step also has the execution status information 130 that contains status 132 of the step and may have the associated message 134.

The type of step 106 may be a comment, a verification point or an action. A comment type step defines instructions created to illustrate a concept, provide further information on the subject under test, etc. A verification point step is an instruction created to perform a specific validation for a scenario being executed. An action step is an instruction for an action that is taken by a tester.

The instruction steps also include an indication of the user that executed the step 136 for each step and the number of times the step has been executed 138. Each test case definition 112 further includes a start date 140 when execution of the test case first started and an end date 142 when the test case was successfully competed. Each test case definition 112 also has an overall status 144 and a test case category 148 indicating the type of test (e.g., automatic or manual test). The test case ID 114, test case name 116, additional information 118, test case description 120, test case category 148, step number 124, step type 126, and instruction 128 may all be set when a test case is created. The start date 140, end date 142, status 144, step status 132, execution step message 134, run user 136 and number of times executed 138 are determined during execution of the test case.

The client 106 allows a user to view a test case and provide a series of steps to be executed for the test. The client 106 also allows the user to set the status of each step during execution of the test case. The client 106 and the server 146 can be remote from each other, allowing a test case to be viewed, run and the status updated at a different location from the server 146. This provides a user with the ability to perform test cases from multiple different locations while still updating test case status information on the server 146 during execution of the test case.

Test Case Creation

The test case is created in the test case database 110 through the client 106 via the definition interface 104. Test case ID 114, test case name 116, test case category 148 and test case steps 122 are entered into the GUI 108 of the client 106 to provide the basic definition for the test case. The test case steps 122 include for each step the step number 124, step type 126 and the instruction 128. This information is supplied to the definition interface 104 where a test case definition 112 is created in the database 110 based on this information. Additional information 118 and test case description 120 information may be optionally included during the creation of the test case definition 112 in the database 110.

Test Case Execution

The test case may be viewed and edited by the client 106 via the testing interface 102. The GUI 108 receives a request to view a test case from a user. This request is sent from the client 106 to the testing interface 102 of the server 146. The testing interface 102 retrieves the requested test case from the database 110. This information is formatted and sent to the client 106 for display by the GUI 108. Test case step instructions 128 may be displayed on the GUI 108 allowing each step to be sequentially executed. As each test case step 122 is executed information on execution outcome 130, run user 136 and number of times executed 138 are gathered by the client 106.

This information is passed to the testing interface 102 to update this information in the database 110. After a test case step 122 is executed a user enters updated status information 132 to the GUI 108. The user may also add message information in correspondence with the status of each test case step 122. The client 106 automatically gathers run user information 136 and the number of times the test case step has been executed 138 during user interaction with the test case information.

The client 106 supplies the testing interface 102 with execution date information of any changes to status of the steps 122 of the test case. The testing interface 102 can compare this date information with the start date 140 and the end date 142 of the test case. This allows the testing interface 102 to set the start date 140 with the currently supplied execution date if not yet set. After updating the step status 132 for steps 122 according to information provided by the client 106, the testing interface 106 examines the status of all steps 122 in the test case definition 112. If all steps 122 have a passed or completed status then the status 144 of the test case definition 112 is set to passed or completed and the end date 142 is set to the current execution date supplied by the client 106.

In an embodiment of the present invention the system 100 includes the following:

(a) a GUI that has support to show a test case name and description;

(b) a grid that contains the sequence of steps to be executed;

(c) a mechanism to submit state changes to the central system;

(d) a facility for ad hoc comments to be made regarding each step; and

(e) a mechanism to add steps to a script.

Each step from (b) has an associated status. This is generally configurable to a fixed set of choices and has a default state of “un-attempted”.

In practice, the GUI is fed a string for the name, a string for the description, a set of sequences for the steps, and a set of sequences for the possible states with one identified as the default. A separate process is implemented to reconcile items (a)-(d) with an initial test case structure. With respect to step (e), it is common to modify the scripts on an ad-hoc basis. As a result, recording them immediately at test execution time minimizes the risk of losing valuable information. As a final step, the system receives an input string as an XML fragment and submits an XML fragment when reporting status.

The GUI is part of a client that is capable of running remote from a server containing a database with test case information.

Since the system is effectively a running application, it can be used to integrate a manual test process step into another automated process system. More specifically, the test automation system simply runs an application as a step in the overall process; the application being a program that interacts with one or more local or remote testers accumulating results in a central system.

The client may run on the machine being used to do the testing. Alternatively, it can be implemented on a wireless device or an alternate machine. Further, the client can be implemented using Java, for example, or any other UI metaphor or language (e.g., XSL in a browser).

In another embodiment of the present invention the client 106 may include the testing interface 102 and the definition interface 104 and the client interface 150. The testing interface 102 and the definition interface 104 are linked to the database 110.

Alternatively, the client interface 105, the testing interface 102 and the definition interface 104 may connect the database 110 and the client 106 but be remote from both.

The client interface 150, the testing interface 102, and the definition interface 104 of the present invention may interface with a plurality of clients.

In summary, the system provides timely feedback fo test case execution data, significantly reduces potential errors in data and is configurable into an automated tracking system.

The embodiments of the invention in which an exclusive property or privilege is claimed are defined as follows:

1. A system for managing interaction with test cases for manual testing of software by a test client, the test client displaying the test cases for interaction by a tester, said system comprising:
a client interface for communicating with a plurality of clients, the test client being one of said plurality of clients;
a data storage containing a test case definition representing a test instruction set of a test case, said test case definition having step definition information with an instruction step to be executed manually and execution status information for said instruction step;
interaction means for governing interactions with said test case definition in said data storage, said interaction means providing said test case definition to said client interface for display on the test client; and
step manipulation means for handling manipulation of said instruction step of said test case definition in said data storage;
wherein the test client provides said client interface with a manipulation command for said test case definition and said interaction means governs said manipulation command for said test case definition in said data storage.

2. The system according to claim 1, wherein said interaction means includes construction means for constructing said test case definition in said data storage, and wherein said manipulation command includes definition information for constructing said test case definition.

3. The system according to claim 1, wherein said manipulation command includes said execution status information, and wherein said interaction means includes an editorial manager for coordinating said manipulation command with said step manipulation means to update said execution status information.

4. The system according to claim 3, wherein said step manipulation means includes status updating means for changing said execution status information of said instruction step in said data storage.

5. The system according to claim 1, wherein said client interface includes date determining means for determining a date at which said manipulation command was received from said test client.

6. The system according to claim 5, wherein said interaction means includes start date determining means for determining a start date at which said test case definition has been initially executed and including said start date in said test case definition in said data storage.

7. The system according to claim 5, wherein said interaction means includes status determining means for examining said execution status information for said instruction step to determine a test case execution status for said test case definition and including said test case execution status in said test case definition in said data storage.

8. The system according to claim 7, wherein said interaction means includes end date determining means for determining a end date at which said test case execution status for said test case definition has a status of complete and including said end date in said test case definition in said data storage.

9. The system according to claim 1 where said test client is remotely located from said data storage.

10. A system for managing interaction with test cases for manual testing of software by a test client in communication with a data storage containing a test case definition representing a test instruction set of a test case, said test case definition having step definition information including an instruction step to be executed manually and execution status information for said instruction step, the test client displaying the test cases for interaction by a tester, said system comprising:
a client interface for communicating with a plurality of clients, the test client being one of said plurality of clients;
interaction means in communication with the data storage for governing interactions with said test case definition in said data storage, said interaction means providing said test case definition to said client interface for display on the test client; and
step manipulation means in communication with the data storage for handling manipulation of said instruction step of said test case definition in said data storage;
wherein the test client provides said client interface with a manipulation command for said test case definition and said interaction means governs said manipulation command for said test case definition in said data storage.

11. The system according to claim 10, wherein said interaction means includes construction means for constructing said test case definition in said data storage, and wherein said manipulation command includes definition information for constructing said test case definition.

12. The system according to claim 10, wherein said manipulation command includes said execution status information, and wherein said interaction means includes an editorial manager for coordinating said manipulation command with said step manipulation means to update said execution status information.

13. The system according to claim 12, wherein said step manipulation means includes status updating means for changing said execution status information of said instruction step in said data storage.

14. The system according to claim 10, wherein said client interface includes date determining means for determining a date at which said manipulation command was received from said test client.

15. The system according to claim 14, wherein said interaction means includes start date determining means for determining a start date at which said test case definition has been initially executed and including said start date in said test case definition in said data storage.

16. The system according to claim 14, wherein said interaction means includes status determining means for examining said execution status information for said instruction step to determine a test case execution status for said test case definition and including said test case execution status in said test case definition in said data storage.

17. The system according to claim 16, wherein said interaction means includes end date determining means for determining a end date at which said test case execution status for said test case definition has a status of complete and including said end date in said test case definition in said data storage.

18. A method of managing test cases for manual testing of software from a test client, information representing the test cases being stored in a data storage, said method comprising:
(a) receiving test case definition information from the test client representing a test case;
(b) creating a data structure in the data storage representing said test case definition information, said data structure including test case identification, a test instruction set having step definition information including an instruction step to be executed manually and execution status information for said instruction step, and test case execution information;
(c) receiving a manipulation command for said data structure from the test client, said manipulation command having step definition information; and
(d) updating said step definition information in said data structure based on said step definition information in said manipulation command.

19. The method according to claim 18 further including:
(e) updating said test case execution status information based on updating of said step definition information in step (d).

20. The method according to claim 18 wherein the step of (d) updating said step definition information includes (i) adding a new instruction step to said test instruction set

21. The method according to claim 18 wherein the step of (d) updating said step definition information includes (ii) editing said instruction step.

22. The method according to claim 18 wherein the step of (d) updating said step definition information includes (iii) changing said execution status information.

23. The method according to claim 19 wherein the step of (e) updating said test case execution status information includes (i) determining a start date at which said test case definition has been initially executed; and (ii) inserting said start date in said data structure.

24. The method according to claim 19 wherein the step of (e) updating said test case execution status information includes (iii) examining said execution status information for said instruction step to determine a test case execution status for said test case definition; and (iv) inserting a new test case execution status in said test case execution information in said data structure.

25. The method according to claim 19 wherein the step of (e) updating said test case execution status information includes (v) determining an end date at which said test case execution status information has a status of complete; and (vi) inserting a new test case execution status in said test case execution information in said data structure.

26. A computer readable medium having stored thereon computer-executable instructions for managing test cases being stored in a data storage, comprising:
(a) receiving test case definition information from the test client representing a test case;
(b) creating a data structure in the data storage representing said test case definition information, said data structure including test case identification, a test instruction set having step definition information including an instruction step to be executed manually and execution status information for said instruction step, and test case execution information;
(c) receiving a manipulation command for said data structure from the test client, said manipulation command having step definition information; and
(d) updating said step definition information in said data structure based on said step definition information in said manipulation command.

27. The computer-readable medium according to claim 26 further including:
(e) updating said test case execution status information based on updating of said step definition information in step (d).

28. The computer-readable medium according to claim 26 wherein the step of (d) updating said step definition information includes (i) adding a new instruction step to said test instruction set.

29. The computer-readable medium according to claim 26 wherein the step of (d) updating said step definition information includes (ii) editing said instruction step.

30. The computer-readable medium according to claim 26 wherein the step of (d) updating said step definition information includes (iii) changing said execution status information.

31. The computer-readable medium according to claim 27 wherein the step of (e) updating said test case execution status information includes (i) determining a start date at which said test case definition has been initially executed; and (ii) inserting said start date in said data structure.

32. The computer-readable medium according to claim 27 wherein the step of (e) updating said test case execution status information includes (iii) examining said execution status information for said instruction step to determine a test case execution status for said test case definition; and (iv) inserting a new test case execution status in said test case execution information in said data structure.

33. The computer-readable medium according to claim 27 wherein the step of (e) updating said test case execution status information includes (v) determining an end date at which said test case execution status information has a status of complete; and (vi) inserting a new test case execution status in said test case execution information in said data structure.
